(19) United States
(12) Patent Application Publication
(10) Pub. No.: US 2025/0295045 A1
(43) Pub. Date: Sep. 25, 2025

(54) System and Method for Turf Aerification

(71) Applicant: Thomas N. Tremblay, JR., Sunny Isles Beach, FL (US)

(72) Inventor: Thomas N. Tremblay, JR., Sunny Isles Beach, FL (US)

(21) Appl. No.: 18/611,136

(22) Filed: Mar. 20, 2024

(51) Int. Cl. A01B 45/02

(52) U.S. Cl. CPC A01B 45/023

(57) ABSTRACT

A system and method for aerating turf including an eight-tine block for use in combination with an approximately ⅜-inch or less in diameter tine in a self-propelled mechanized turf aerator with a forward movement setting of 1.5-inch between downward movements of the tine block. The system includes a self-propelled mechanized turf aerator; a 2×4 tine block affixed to the self-propelled mechanized turf aerator, the 2×4 tine block including two rows of four holes in each row, each hole sized approximately ⅜-inch in diameter; and tines including a proximal end of about ⅜-inch in diameter for insertion into the 2×4 tine block holes, and a distal end about ⅜-inch or less in diameter for insertion into a turf site.

### FIELD OF THE DISCLOSURE

The invention relates generally in one embodiment to a system and method for aerating turf, and more particularly, to an eight-tine block and its use in combination with an approximately ⅜-inch diameter or smaller tine in a self-propelled mechanized turf aerator.

### BACKGROUND

To promote healthy turf, turf should be periodically aerated. Turf aeration is accomplished primarily in two ways. First, a solid tine may be inserted into the turf to a desired depth to create a turf aeration hole. Second, a coring tine may be inserted into the turf to a desired depth to remove a turf core and thus create a turf aeration hole.

To avoid the creation of turf aeration holes manually, mechanized turf aerators have been developed and are commonly used. Perhaps the most widely used self-propelled mechanized turf aerator is the Toro ProCore 648 available from The Toro Company (Bloomington, MN). This self-propelled mechanized aerator is suitable for use on golf course greens.

In a self-propelled mechanized turf aerator like the ProCore 648, either six or ten tines are loaded into a tine block. A prior art ten-tine block 10 is shown in FIG. 1A, which is a 2×5 tine block, in that the tine block 10 includes two rows of five holes 20 into which tines may be inserted and held in place by set screws 30. A prior art six-tine block is shown in FIG. 1B, which is called a 1×6 tine block, but in reality is a 2×3 tine block in that the tine block 40 includes two rows of three holes into which tines 50 may be inserted. The tine blocks 40 include ⅜-inch holes into which one end of a tine 50 is inserted. The inserted end is known as the tine's mount and has about a ⅜ inch outer diameter. Then, a set screw 60 is used to hold the tine 50 within the tine block 40. The tine block 40 with tines 50 is then attached to the self-propelled mechanized aerator with bolts at mounting holes 70 in mounting flange 80. Typically, as in the case of the Toro ProCore 648, six-tine blocks 40 with tines 50 are loaded into the self-propelled mechanized aerator. The mechanized aerator is placed at a desired location for turf aeration. The tine

blocks with tines loaded into the mechanized aerator move downwardly so that the tines are inserted into the turf to a desired depth. Then, the tine blocks with tines move upwardly so that the tines are withdrawn from the turf. The mechanized aerator is moved forward a desired distance, at which time the process of tine block movement is repeated. For example, the Toro ProCore 648 self-propelled mechanized aerator can be set so that the tines penetrate the turf after a forward movement of either 1.5 inches, 2 inches, 2.5 inches, or 3 inches.

Use of a smaller forward movement setting is generally preferred, as that results in more holes being punched into a particular section of turf. Similarly, use of tine blocks that hold more tines is generally preferred, as that also results in more holes in the turf. Better aeration is achieved with a greater number of holes being placed in a section of turf.

A problem exists, however, when using the Toro ProCore 648 mechanized aerator at the 1.5-inch forward movement setting in combination with a prior art ten-tine block 10. The rows of holes created in the turf will overlap or come very close together, resulting in the virtual destruction of the turf surface. This result is particularly problematic when aerating turf on a golf course, and especially the putting greens of the golf course. This is why the Toro ProCore 648 mechanized aerator use instructions make clear that the 1.5-inch forward movement setting should not be used when using a ten-tine block 10; the manufacturer recommends a minimum 2.5-inch forward movement setting.

Accordingly, a turf aeration system and method are required for improved aerification of turf by the establishment of a greater number of holes in a section of turf.

### SUMMARY

The present disclosure in one embodiment provides a system and method for turf aerification comprising use of an eight-tine block in combination with an approximately ⅜-inch diameter or smaller tines in a self-propelled mechanized turf aerator with a 1.5-inch forward movement setting. The block includes two rows of four ⅜-inch holes into which tines may be inserted (i.e., a 2×4 tine block). The tines to be inserted in the 2×4 tine block are sized equal to or less than approximately ⅜-inch in diameter. In one embodiment, the tines to be inserted include a ⅜-inch mount and a 0.275-inch outer diameter. In another embodiment, the tines to be inserted include a ⅜-inch mount and a 0.315-inch outer diameter. In another embodiment, the tines to be inserted include a ⅜-inch mount and a 0.196-inch outer diameter. In one embodiment, the tines are solid tines. In another embodiment, the tines are coring tines. This smaller tine used in combination with the 2×4 tine block provides excellent aeration of turf as compared to prior used methods. The combination is particularly suitable for use on golf course greens.

Other benefits and advantages of the present disclosure will be appreciated from the following detailed description.

### DESCRIPTION OF THE DRAWINGS

FIG. 1A is a bottom view of a prior art 2×5 tine block.

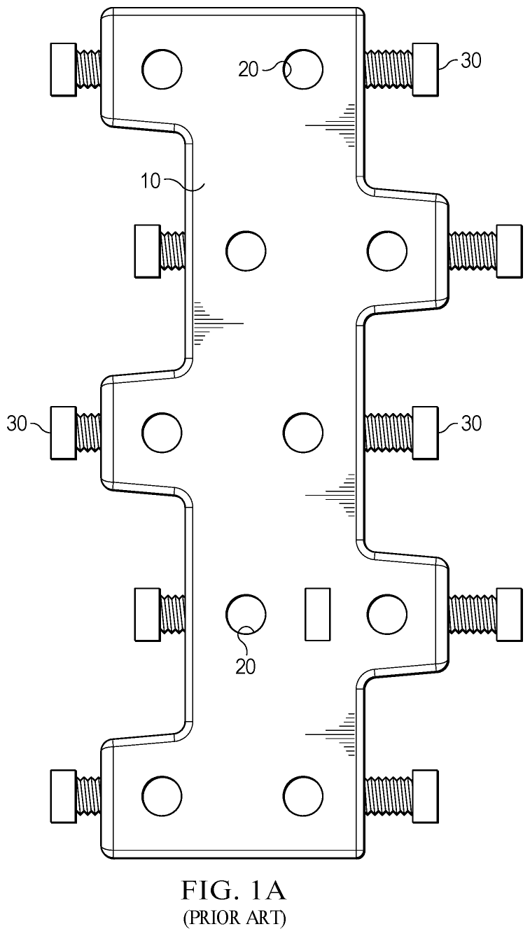

FIG. 1B is a perspective view from below of a prior art 2×3 tine block including inserted coring tines.

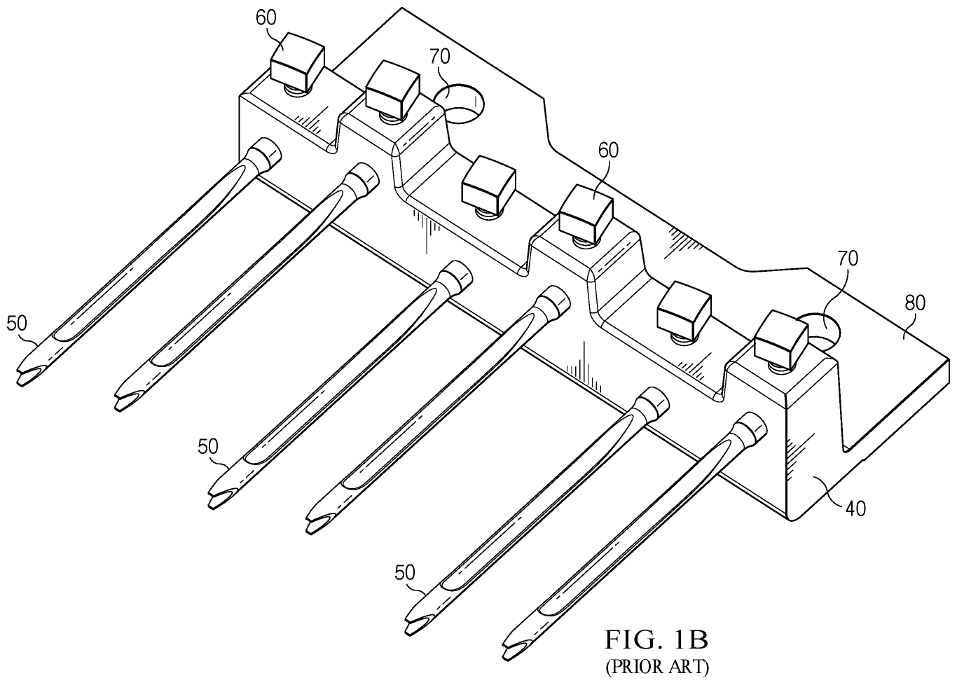

FIG. 2 is a perspective view from below of a 2×4 tine block including coring tines, as described herein.

FIG. 3 is a bottom view of the 2×4 tine block shown in FIG. 2, without tines.

FIG. 4 is a perspective view from above of the 2×4 tine block shown in FIG. 2, without tines.

FIG. 5 is a top view of a self-propelled mechanized aerator turf guard for use with the 2×4 tine block as described herein.

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to turf aeration; etc. Such aspects related to this disclosure do not depart from the invention, and it is therefore intended that the invention not be limited by the certain aspects set forth of the events and circumstances related to this disclosure.

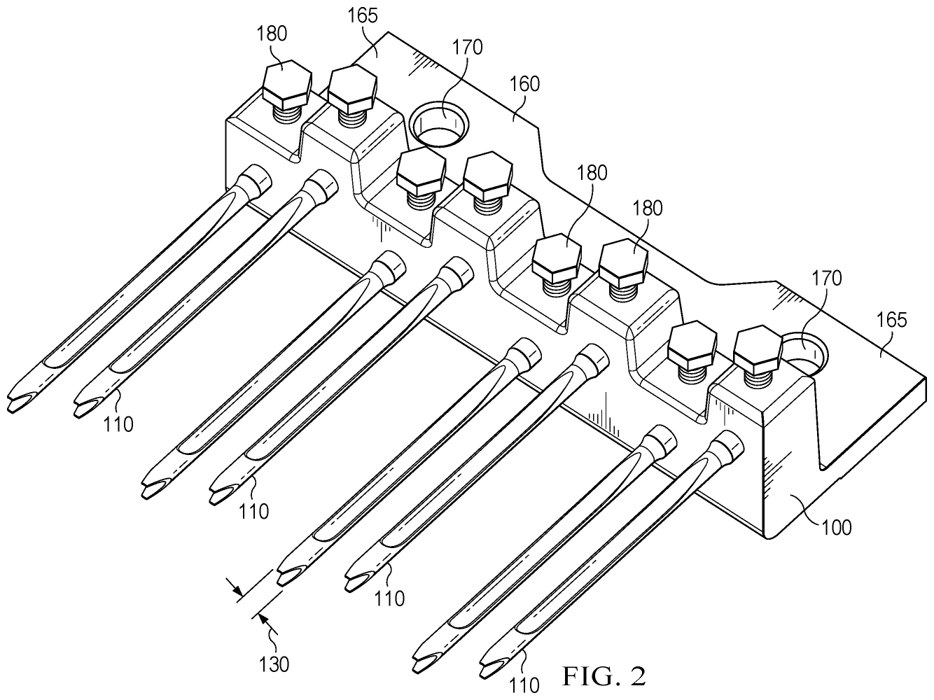

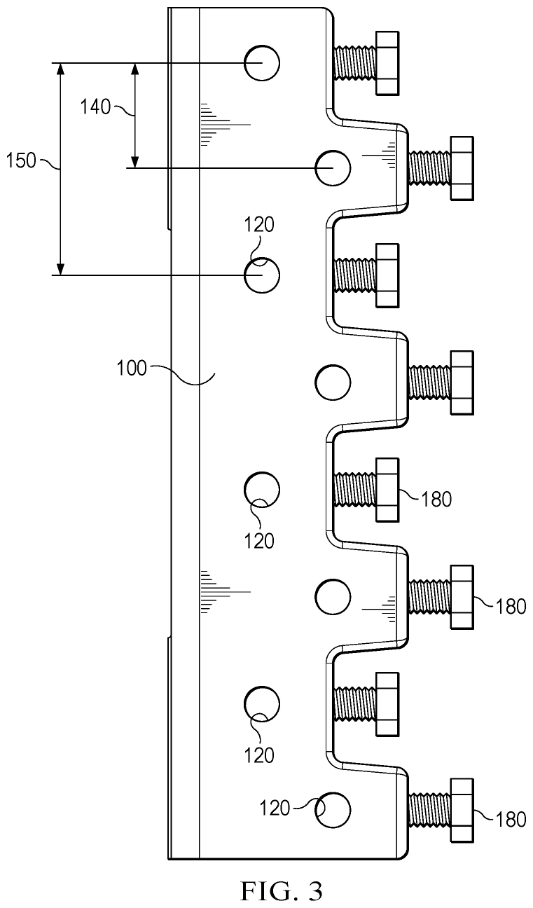

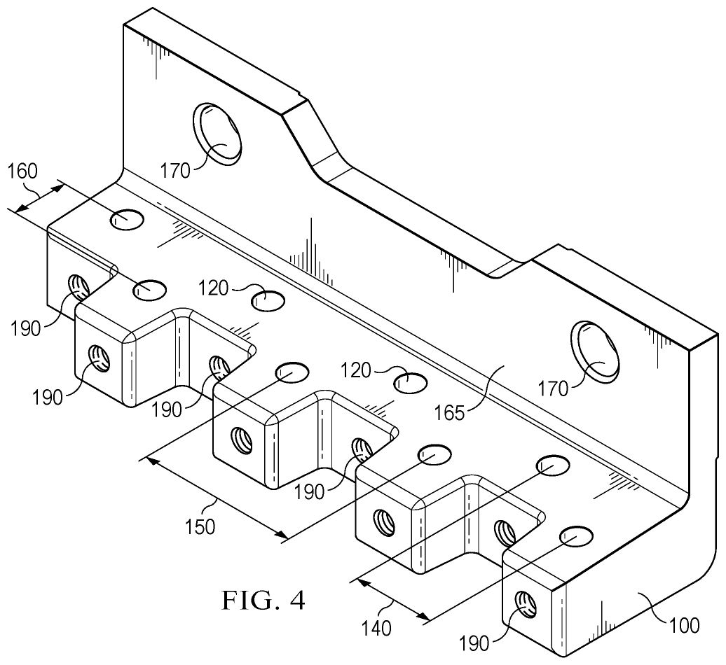

Turning to the drawings, an exemplary 2×4 tine block 100 is shown in FIGS. 2-4. The tine block 100 includes two rows of four ⅜-inch holes 120 into which one end of an aerification tine 110 may be inserted. In one embodiment, the rows of holes 120 are laterally offset, so that the first hole in the second row of holes is generally centrally disposed laterally between the first and second holes of the first row of holes. The lateral spacing 150 of the holes in a particular row is approximately 1.916 inches center-to-center, meaning that the lateral offset 140 of the first hole of the first row from the first hole of the second row is approximately 0.958 inches center-to-center. The forward spacing 160 of the centerlines of the rows of holes is approximately 0.585 inches.

The 2×4 block 100 includes a mounting flange 165 including mounting sites 170. The mounting sites 170 may be holes at which the block 100 and flange 165 are bolted to a self-propelled mechanized aerator.

Tines 110 are held in place by set screws 180. The set screws 180 are disposed in holes 190 which extend into block 100 to their corresponding holes 120. Mounting the tines 110 into the block 100 involves loosening the set screws 180, inserting the mount ends of the tines 110 into the holes 120, and tightening the set screws 180 against the inserted mount ends.

An aerification method in accordance with the present disclosure comprises the steps of: (a) providing a 2×4 tine block; (b) loading the 2×4 tine block with tines that include a distal end approximately 0.315-inch or 0.275-inch or 0.196-inch in diameter, to create a loaded 2×4 tine block; (c) placing the loaded 2×4 tine block in a self-propelled mechanized turf aerator; (d) positioning the loaded 2×4 tine block at a desired turf site to be aerated; and (e) inserting the distal end of the tines into the turf site.

In an alternate embodiment, an aerification method in accordance with the present disclosure comprises the steps of: (a) providing a 2×4 tine block; (b) placing the 2×4 tine block in a self-propelled mechanized turf aerator; (c) loading the 2×4 tine block with tines that include a distal end approximately 0.315-inch or 0.275-inch or 0.196-inch in diameter, to create a loaded 2×4 tine block; (d) positioning the loaded 2×4 tine block at a desired turf site to be aerated; and (e) inserting the distal end of the tines into the turf site.

In one embodiment, the tines used in combination with the 2×4 tine block may be solid tines. In another embodiment, the tines used in combination with the 2×4 tine block may be coring tines. An exemplary coring tine is shown in FIG. 2.

The system and method of the present disclosure may be minimally disruptive to a turf site surface. For example, where the turf site is a putting green, and the tines used are coring tines, the turf cores provided by the aerification process may be blown off the putting green, and the putting green rolled and/or mowed, to permit immediate golf play at the putting green following aerification.

When a self-propelled mechanized aerator is set for 1.5-inch forward travel between tine block downward movements, use of the described 8-tine block in combination with 0.315-inch or 0.275-inch or 0.196-inch in diameter tines creates one hundred aerification holes per square foot, which greatly exceeds the number of holes that are produced at the same 1.5 inch forward travel setting with such tines in a prior art 6-tine block. Use of the 6-tine block results in only 72 holes per square foot. Again, the prior art 10-tine block cannot be used with a 1.5-inch forward travel setting. When used with a 2.5-inch forward travel setting (i.e., the manufacturer's recommended setting), the 10-tine block used with such tines results in 72 holes per square foot. Thus, greater turf aerification is achieved through use of the described 8-tine block.

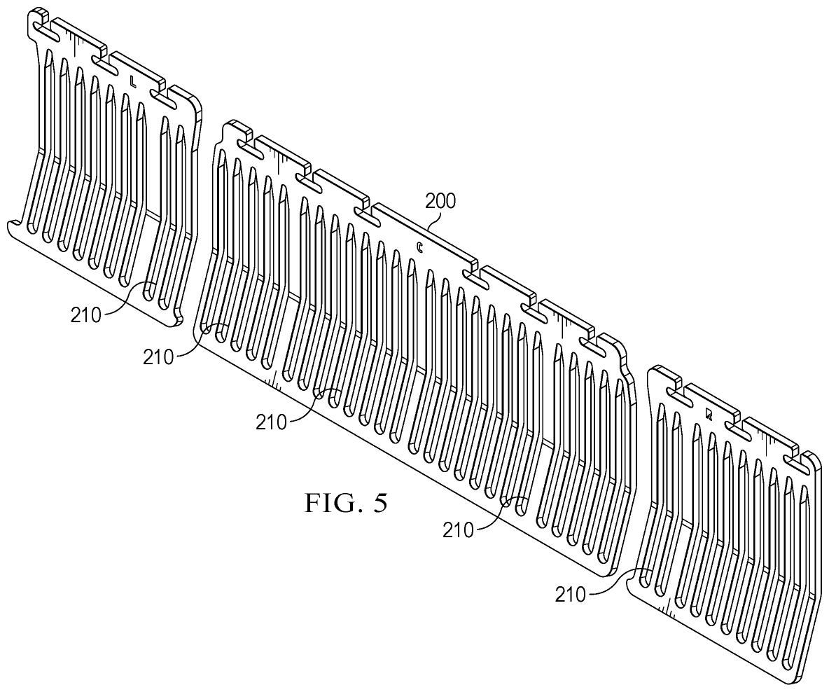

An exemplary turf guard 200 is described in FIG. 5 that may be used with the 8-tine block described herein. As shown in the drawing, the turf guard 200 includes a plurality of slots 210 corresponding to the locations of tines installed in the 8-tine blocks. Each tine passes through a slot 210 as it is inserted and withdrawn from the turf being aerated. The portions of the turf guard 200 proximate each slot 210 press against the turf surface to help promote non-disruption of the turf by movement of the tines through the slots 210. As shown in FIG. 5, the turf guard 200 may be used with up to six 8-tine blocks installed in a self-propelled mechanized aerator.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of examples and described in detail herein. However, it should be understood that the invention is not intended to be limited to the particular forms disclosed. Rather, the invention is to cover all modifications, equivalents and alternatives falling within the spirit and scope of the invention.

What is claimed is:

1. A system for turf aerification including: (a) a self-propelled mechanized turf aerator; (b) a 2×4 tine block affixed to the self-propelled mechanized turf aerator, the 2×4 tine block including two rows of four holes in each row, each hole sized approximately ⅜-inch in diameter, and including a lateral offset of the first hole of the first row from the first hole of the second row of approximately 0.958 inches center-to-center; and (c) tines, each including a proximal end of about ⅜-inch in diameter, inserted into the 2×4 tine block holes, and a distal end about 0.315-inch or 0.275-inch or 0.196-inch in diameter for insertion into a turf site.

2. The system of claim 1, wherein the tines are solid tines.

3. The system of claim 1, wherein the tines are coring tines.

4. The system of claim 1, including a set screw for securing each tine in each hole.

5. A system for turf aerification including: (a) a 2×4 tine block, the 2×4 tine block including two rows of four holes in each row, each hole sized approximately ⅜-inch in diameter; and (b) tines including a proximal end of about ⅜-inch in diameter for insertion into the 2×4 tine block holes, and a distal end about 0.315-inch or 0.275-inch or 0.196-inch in diameter for insertion into a turf site by a self-propelled mechanized aerator.

6. The system of claim 5, wherein the tines are solid tines.

7. The system of claim 5, wherein the tines are coring tines.

8. The system of claim 5, including a set screw for securing each tine in each hole.

9. A method of turf aerification including:
providing eight tines, wherein each tine includes a tine mount portion of approximately ⅜-inch in diameter and a tine outer diameter of about 0.315-inch or 0.275-inch or 0.196-inch;
providing a self-propelled mechanized aerator set at 1.5-inch forward travel between successive insertion of the tines into turf; and
providing a 2×4 tine block, the 2×4 tine block including two rows of four holes in each row, each hole sized approximately ⅜-inch in diameter, and wherein the lateral offset of the first hole of the first row from the first hole of the second row is approximately 0.958 inches center-to-center.

10. The method of claim 9 further including the steps of: inserting the tine mount portions into the 2×4 tine block holes to create a loaded tine block; and installing the loaded tine block into the self-propelled mechanized aerator.
